(19) United States
(12) Patent Application Publication
(10) Pub. No.: US 2026/0310919 A1
(43) Pub. Date: Oct. 8, 2026

(54) SYSTEM AND METHOD OF EMBEDDING SMART TRIGGERS FOR CONTROLLED CONTENT

(71) Applicant: QR Flask, LLC, Chagrin Falls, OH (US)

(72) Inventor: Joshua Korth, Chagrin Falls, OH (US)

(21) Appl. No.: 19/639,853

(22) Filed: Apr. 6, 2026

Related U.S. Application Data
(60) Provisional application No. 63/783,226, filed on Apr. 4, 2025.
(60) Provisional application No. 63/843,269, filed on Jul. 14, 2025.
(60) Provisional application No. 63/844,035, filed on Jul. 15, 2025.
(60) Provisional application No. 63/844,037, filed on Jul. 15, 2025.

(51) Int. Cl. G06K 19/06; G06F 21/30

(52) U.S. Cl. CPC G06K 19/06103; G06F 21/30; G06K 19/06037

(57) ABSTRACT

A computing system is disclosed for controlling access to digital content in response to interaction with a machine-readable element associated with a physical product. The system receives a request from a user device generated upon detection of the machine-readable element, identifies the associated element or product, and determines whether an access condition is satisfied based on device-related data, interaction context data, or prior interaction data. When the access condition is satisfied, the system selects content data based on the identified element or product and at least one of scheduling rules, personalization data, or campaign parameters, and causes transmission of the selected content to the user device for presentation.

### CROSS-REFERENCES TO RELATED APPLICATIONS

This patent application claims priority to each of U.S. Provisional Patent Application Ser. No. 63/783,226, filed on Apr. 4, 2025, U.S. Provisional Patent Application Ser. No. 63/843,269, filed on Jul. 14, 2025, U.S. Provisional Patent Application Ser. No. 63/844,035, filed on Jul. 15, 2025, and U.S. Provisional Patent Application Ser. No. 63/844,037, filed on Jul. 15, 2025, the disclosures of which are hereby incorporated herein by reference in their entireties.

### FIELD OF THE INVENTION

The invention relates generally to systems and methods for linking physical products to digital content, and more particularly, to systems and methods that enable interaction between users and machine-readable elements associated with such physical products.

### BACKGROUND

Conventional approaches for connecting physical items to digital resources typically rely on static identifiers, such as uniform resource locators (URLs) encoded in QR codes or similar elements, which direct users to fixed web pages or content endpoints. However, such conventional systems suffer from several shortcomings. In particular, static linking mechanisms do not provide flexibility in controlling or modifying content after deployment of the physical product, thereby limiting the ability of a business entity to adapt content over time or in response to user behavior. Additionally, known systems generally lack mechanisms for distinguishing between users who directly interact with a physical product and users who access content indirectly, such as through sharing of a link, thereby reducing the ability to enforce access conditions or maintain a meaningful association between the physical product and the delivered content.

Further, existing systems typically do not provide integrated capabilities for tracking user interactions, personalizing content based on user-specific data, or enabling engagement features such as rewards, incentives, or dynamic content updates tied to repeated interactions. As a result, such systems are limited in their ability to provide ongoing engagement with users or to support marketing, promotional, or commerce-related activities associated with physical products. Moreover, conventional approaches often fail to provide business entities with meaningful analytics regarding user interactions, thereby limiting the ability to evaluate effectiveness of campaigns or refine content strategies.

Accordingly, there is a need for an improved system and method that enables dynamic association between physical products and digital content, supports controlled access to such content based on interaction with machine-readable elements, and allows for modification and personalization of content over time. There is further a need for a system that facilitates interaction between users and business entities through such physical products, including support for engagement features such as rewards and incentives, as well as analytics capabilities for evaluating user interactions.

The present invention addresses these needs by providing a system in which machine-readable elements associated with physical products initiate interaction events that are processed by an enterprise system to deliver controlled, dynamic, and user-specific content. The system supports validation of interaction events, association of interactions with user identities, adaptive content selection, and integration with transactional and promotional features, thereby enabling enhanced engagement between users and business entities through physical products.

### SUMMARY OF THE INVENTION

In accordance with the present disclosure, an improved system and method that enables dynamic association between physical products and digital content has surprisingly been discovered.

According to an embodiment of the present invention, a computing system for controlling access to digital content in response to interaction with a machine-readable element associated with a physical product comprises one or more processors and one or more non-transitory computer-readable media storing instructions that, when executed by the one or more processors, cause the enterprise computing system to: receive, from a user device, a request generated based on detection of the machine-readable element associated with the physical product; identify the machine-readable element or the physical product based on data included in the request; determine whether an access condition is satisfied based on at least one of device-related data, interaction context data, or prior interaction data associated with the machine-readable element or the physical product; select, in response to determining that the access condition is satisfied, content data based on the identified machine-readable element or physical product and at least one of one or more scheduling rules, personalization data, or campaign parameters; and cause transmission of the selected content data to the user device for presentation to a user.

A method for providing controlled access to digital content via a physical product is also disclosed according to the present disclosure, the method comprising the steps of: generating, by a computing system, encoding data associated with a machine-readable element; causing the machine-readable element to be formed or incorporated into a physical product based on the encoding data; associating, by the computing system, the machine-readable element with content data and one or more access conditions; receiving, by the computing system, a request generated by a user device based on detection of the machine-readable element; determining, by the computing system, whether an access condition is satisfied based on at least one of device-related data, interaction context data, or prior interaction data; selecting, by the computing system, content data based on the machine-readable element and at least one of scheduling rules, personalization data, or interaction history; and causing, by the computing system, presentation of the selected content data in reaction to the access condition being satisfied.

### BRIEF DESCRIPTION OF THE DRAWINGS

FIG. 1 illustrates a system environment including a user device and an enterprise system configured to communicate over a network and facilitate interaction with machine-readable elements associated with physical products.

FIGS. 2 and 3 illustrate examples of physical products including machine-readable elements incorporated in QR code format.

FIG. 4 illustrates an alternative embodiment of a physical product including a machine-readable element incorporate as an NFC tag.

FIG. 5 illustrates a cross-sectional view of a multi-layer assembly including a machine-readable element and associated structural layers configured for application to a physical product such as that disclosed in FIG. 4.

FIG. 6 illustrates a process flow diagram representing an interaction event, element detection, request generation, request analysis, request response, data tracking, and reward assignment associated with interaction between a user device and a machine-readable element.

FIG. 7 illustrates an example of an access interface displayed on a user device during execution of a validation process prior to presentation of content associated with a machine-readable element.

FIG. 8 illustrates an example of a content interface displayed on a user device, including content elements associated with a content template and populated with text content, image content, and interactive content.

FIG. 9 illustrates an example of an alternative interface displayed on a user device when authentication of a direct detection of the machine-readable element has failed.

FIG. 10 illustrates a decision flow associated with validation of an access condition, including conditional rendering of either a content interface or an alternative interface based on satisfaction of the access condition.

FIG. 11 illustrates an example of a structured dataset including a plurality of data fields arranged in a tabular format, wherein each set of data fields corresponds to a content entry used to generate content for display on a user device.

FIGS. 12A and 12B illustrate examples of content interfaces that change based on time dependent content logic associated with interactions occurring within different time periods.

FIG. 13 illustrates an example of an analytics interface displayed on a user device, the analytics interface presenting information associated with interaction data, campaign performance, or user engagement metrics.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

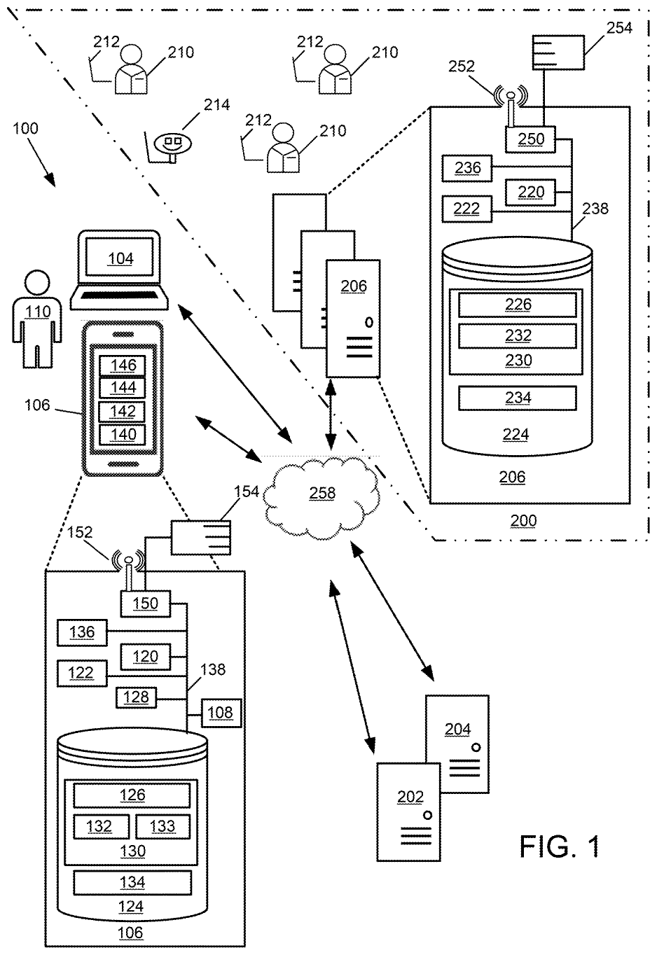

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned or other portable devices with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device. That is, any references hereinafter to only the mobile device 106 may be considered to be inclusive of the computing device 104, wherein the primary differences between the mobile device 106 and the computing device 104 may relate to the manner in which such devices 104, 106 connect to an associated network and the corresponding system components included in each such device 104, 106 for making such network connections. For example, the computing device 104 may in some circumstances include the ability to form only a limited number of network connections via a relatively limited number or variety of different communication devices, methodologies, and/or protocols, such as lacking geolocation tracking capabilities due to a lack of integrated communication interfaces and/or devices, whereas an associated mobile device 106 may include the ability to connect to additional networks in comparison to the computing device 104 in view of the potential availability of an increased number of such communication interfaces and/or devices being integrated into the mobile device 106 and associated with general use thereof. However, it should generally be understood that either of the computing device 104 or the mobile device 106 may include any of the communication interfaces and/or devices as described hereinafter regardless of which type of device 104, 106 is referenced hereinafter in describing the present invention.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device 104, 106, as illustrated with reference to the exemplary mobile device 106 of FIG. 1, includes components including at least one of each of a processing device 120 and a memory device 122 for processing use, such as random access memory (RAM) and/or read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, which may include a browser application 132 and/or a dedicated application 133 associated with carrying out the methods of the present invention. The storage device 124 can store various other data items 134, which can include, as non-limiting examples, cached data, user files such as those for pictures, audio and/or video recordings, files downloaded or received from other devices, and other data items that are preferred by the user or that are required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the user devices 104, 106 described herein. For example, the memory device 122 may include an application such as a conventional web browser application. Such applications also typically provide a graphical user interface (GUI) on the display 140 that allows the user 110 to communicate with the mobile device 106 and any other external devices or systems. In one embodiment, when the user 110 decides to utilize a specific application, the user 110 downloads or otherwise obtains the application from such an external system, for example the enterprise system 200, or from a distinct application server. In other embodiments, the user 110 interacts with the enterprise system 200 via the web browser application in addition to, or instead of, the dedicated application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content, dynamically generated content, and/or remotely hosted content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user device 104, 106 may also include a positioning device 108, which can be a global positioning system (GPS) device that is configured for utilization by a corresponding positioning system to determine a location of the user device 104, 106. For example, the positioning device 108 may include a GPS transceiver. In some embodiments, the positioning device 108 may include an antenna, transmitter, and receiver. For example, in some embodiments, triangulation of cellular signals may be used to identify the approximate location of the user device 104, 106. In other embodiments, the positioning device 108 includes a proximity sensor or transmitter, such as an RFID tag, that can sense or be sensed by devices known to be located proximate a merchant or other location to determine that the user device 104, 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly-by way of intermediate component(s)-with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication (NFC) device, and other transceivers. In addition, GPS services may be included for navigation and location-related data exchanges, whether ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a secure transaction interface. The secure transaction interface may include software, such as encryption software, and hardware, such as a modem, for communicating information to and/or from one or more devices on a network. For example, the mobile device 106 may be configured to transmit and receive authentication data, interaction data, or other secure information to a terminal or system of the network. Such communication may be performed via transmission over a wireless communication protocol such as an NFC protocol or other short-range or wireless communication protocols.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and related services, “service” and “product” are sometimes termed interchangeably. In non-limiting examples, services and products may include retail services and products, information services and products, custom services and products, predefined or pre-offered services and products, consulting services and products, advising services and products, forecasting services and products, internet products and services, social media services, content delivery services, digital engagement services, and campaign management services.

To provide access to, or information regarding, some or all the services and products of the enterprise system 200, assistance may be provided by the enterprise system 200. In at least some examples, any number of human agents 210 can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual. Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the mobile device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, files such as content data, content schedules, interaction logs, and token data, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, NFC device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced generally as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is depicted as a single network in FIG. 1 for illustrative convenience, but the network 258 may further represent more than one network or more than one type of network while remaining within the scope of the present disclosure. In some embodiments, the network 258 may be or may provide one or more cloud-based services or operations. The network 258 may be or may include an enterprise or secured network, or may be implemented, at least in part, through one or more connections to the Internet. A portion of the network 258 may be a virtual private network (VPN) or an Intranet. The network 258 can include both wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent transaction processing systems, content delivery systems, or third-party service platforms for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 104, 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared, as needed.

The present invention relates generally to systems and methods by which a user 110 interacts with a physical product 300 incorporating a machine-readable element 302 in order to access digital content and associated engagement features via one or more user devices 104, 106 in communication with an associated enterprise system 200, in accordance with the configuration of the system 100 as illustrated in FIG. 1. In particular, the invention utilizes the system 100 in which the physical product 300 functions as a persistent access point to remotely controlled digital content, such that interaction with the machine-readable element 302 initiates communication between the user device 104, 106 and the enterprise system 200 over the network 258. The enterprise system 200 is configured to manage, store, and deliver predetermined content in response to such interactions, and to control the manner in which such content is presented to the user 110 via the display 140 of the user device.

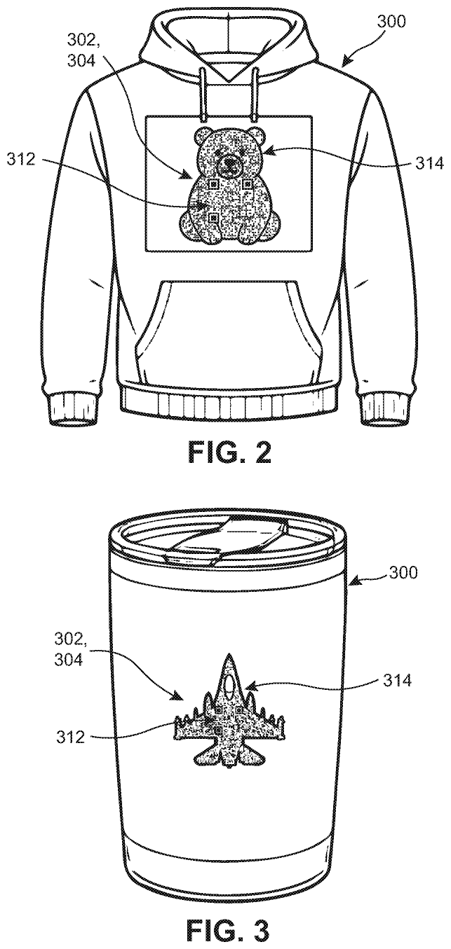

As shown in FIGS. 2-4, the physical product 300 includes or is associated with a representative machine-readable element 302 configured to be detected by the user device 104, 106. The machine-readable element 302 may include, as non-limiting examples, a quick response (QR) code 304, a near-field communication (NFC) tag 306, a radio-frequency identification (RFID) element (not shown), a Bluetooth beacon (not shown), or other device or indicia capable of transmitting or encoding information that can be detected by the user device 104, 106. The machine-readable element 302 may be integrated into the physical product 300 during manufacture, affixed to a surface of the physical product, or otherwise associated with the physical product 300 in a manner that allows the user 110 to interact with the machine-readable element 302 using the user device 104, 106 and while the user is in the physical presence of the associated physical product 300.

The machine-readable element 302 may be configured for optical detection by the camera 146 of the user device 104, 106, such that the processing device 120 executes instructions to decode information encoded within the machine-readable element 302 and initiate communication with the enterprise system 200. In other circumstances or implementations, the machine-readable element 302 is configured for proximity-based detection via the communication interface 150 of the user device 104, 106 such that the user device 104, 106 establishes communication with the machine-readable element 302 upon placement of the user device 104, 106 within a predefined proximity of the physical product 300. The communication interface 150 may include, as non-limiting examples, an NFC interface, a Bluetooth interface, or any other short-range communication interface capable of facilitating such a close-range interaction.

The machine-readable element 302 may be visually or physically integrated into a design associated with the physical product 300. For example, the QR code 304 may be formed within a shaped QR code region 312 and incorporated into a graphical or branded design region 314 while retaining sufficient encoding structure to be detected and decoded by the user device 104, 106. In representative embodiments such as those shown in FIGS. 2 and 3, the shaped QR code region 312 may be defined by a silhouette corresponding to a recognizable figure, logo, or shape, within which the encoding pattern of the QR code 304 is distributed. In such embodiments, the graphical or branded design region 314 may include an outline or border defining the overall shape, along with internal graphical features that visually represent the selected figure. Portions of the QR code 304 may be selectively arranged within the interior of the shaped QR code region 312, such that encoded data modules are positioned around or between graphical elements of the design.

As illustrated in the example of FIG. 2, the shaped design region 314 corresponds to a stylized bear figure having a head portion, body portion, and limb portions, with the QR code 304 of the code region 312 located within the design region 314 while preserving the recognizable form of the bear figure. Alternatively, the example of FIG. 3 includes a shaped design region 314 corresponding to a jet with the code region 312 located within the jet shaped outline. The required structural components of the QR code 304, including position detection patterns and alignment patterns, may be maintained within the shaped QR code region 312 in locations that allow for reliable detection by the user device 104, 106. These structural components may be incorporated into the overall design in a manner that is visually consistent with the graphical or branded design region 314, such as by placing them within central or boundary portions of the figure while maintaining contrast and spacing sufficient for decoding. Additionally, non-critical regions of the design region 314 may be modified or stylized to accommodate graphical features surrounding the code region 312. The design region 314 may be produced with a shaded or patterned appearance that resembles the code region 312 such that the presence of the code region 312 is not overly prevalent relative to the design region 314, thereby maintaining a preferential appearance of the machine-readable element 302 when presented as the QR code 304.

Accordingly, the machine-readable element 302 may be configured to combine functional encoding with aesthetic design, such that the QR code 304 is integrated into a visually distinctive and branded form without compromising its ability to be detected and decoded. This configuration enables the machine-readable element 302 to serve both as an interactive access point to digital content and as a visually engaging, decorative, or expressive component of the physical product 300.

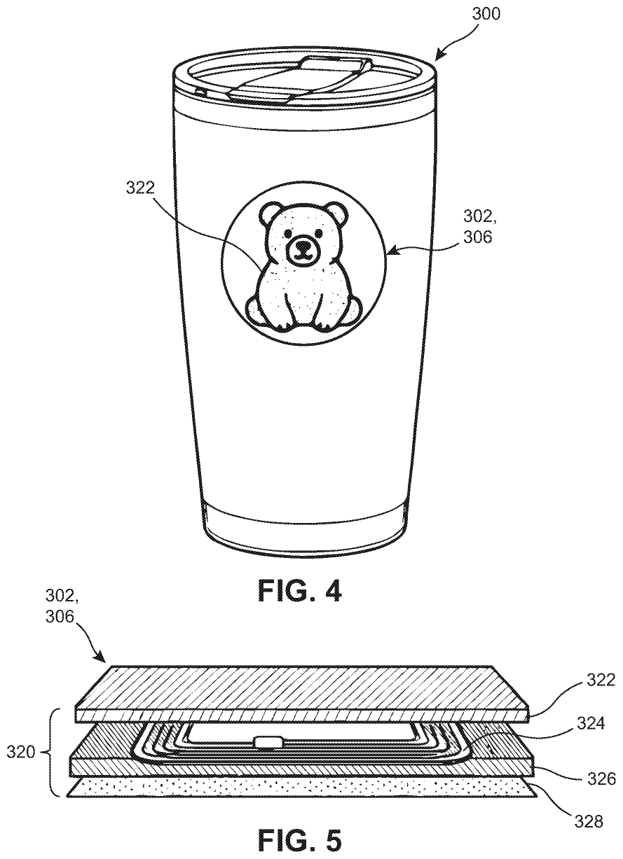

In other embodiments, such as that shown in the example of FIG. 4, the machine-readable element 302 may be provided as the previously mentioned NFC interface 306 that is incorporated into a multi-layer assembly 320. The multi-layer assembly 320 may include an adhesive-backed structure including one or more functional layers configured to support communication with the user device 104, 106 when applied to a surface of the physical product 300. As shown in FIG. 5, the multi-layer assembly 320 may include, as non-limiting examples, an outer layer 322, a communication layer 324, a shielding layer 326, and an adhesive layer 328, thereby enabling reliable operation of the machine-readable element 302 across a variety of product types and surface materials.

As shown in the example of FIG. 4, the outer layer 322 may include a graphic or other indicia formed thereon that provides a visual representation of a product, service, or a business entity representing the source of such goods or services. For example, the graphic or indicia may represent a logo or other similarly identifiable or trademarked representation of the product, service, or the associated business entity. In some embodiments, the outer layer 322 may be formed of a printable or otherwise modifiable material configured to receive the graphic via one or more application processes, including printing, engraving, embossing, or application of a pre-formed label. The graphic or indicia may be selected to correspond to content associated with the machine-readable element 302, thereby providing a visual cue to the user 110 regarding the nature of the content accessible through interaction with the machine-readable element 302.

In certain embodiments, the outer layer 322 may further be configured to maintain visibility and durability of the graphic during repeated use of the physical product 300, including exposure to environmental conditions such as moisture, temperature variation, or physical contact. The outer layer 322 may also be configured to preserve functionality of the underlying communication layer 324, such that the presence of the graphic does not interfere with operation of the machine-readable element 302. In this regard, the outer layer 322 may be formed of materials and thicknesses selected to balance aesthetic presentation with reliable communication performance of the multi-layer assembly 320.

The machine-readable element 302 may be formed using one or more material modification processes applied directly to a surface of the physical product 300. For example, the QR code 304 may be formed by engraving, etching, laser marking, or otherwise modifying a surface of the physical product 300, such as a metallic or polymer surface, to define the encoded pattern. In such embodiments, the encoded structure of the QR code 304 may be defined by variations in surface depth, reflectivity, texture, or coloration, thereby enabling optical detection by the camera 146 of the user device 104, 106 without requiring application of a separate label or printed layer. The engraving process may be configured to produce sufficient contrast between encoded regions and surrounding material to maintain reliable decoding while providing a durable and permanent implementation of the machine-readable element 302.

The machine-readable element 302 may be incorporated into wearable or portable physical products 300, including, as non-limiting examples, wristbands, bracelets, badges, lanyards, or similar items configured to be worn or carried by the user 110. In such embodiments, the machine-readable element 302, such as an NFC tag 306, may be embedded within a housing or band structure that positions the communication layer 324 in proximity to the exterior surface of the physical product 300. The wearable configuration may facilitate repeated and convenient interaction with the user device 104, 106, including tap-based interactions enabled by the communication interface 150, while maintaining durability and comfort for the user 110 during extended use.

In further embodiments, the machine-readable element 302 may be integrated into textile-based or flexible materials forming part of the physical product 300, including clothing, apparel, or fabric-based accessories. For example, the machine-readable element 302 may be incorporated into a garment through attachment of a label, patch, or embedded component that includes a QR code 304, NFC tag 306, or other communication element. In such embodiments, the machine-readable element 302 may be positioned in a location that is accessible for interaction while remaining visually integrated with the design of the physical product 300, thereby enabling the physical product to function as both a wearable item and an interactive interface for accessing digital content.

The physical product 300 may include a wide range of consumer or commercial items configured to incorporate the machine-readable element 302, including drinkware, containers, packaging, signage, or other items distributed to users 110 in connection with a product, service, or promotional activity. The machine-readable element 302 may be incorporated into such products using any of the techniques described herein, including engraving, printing, or multi-layer assemblies, and may be configured to maintain functionality across repeated use, handling, or environmental exposure. In this regard, the system 100 enables the machine-readable element 302 to be deployed across a diverse set of physical products 300, each serving as a persistent and reusable access point to content managed by the enterprise system 200.

In use, the user 110 interacts with the machine-readable element 302 using the user device 104, 106, which detects the machine-readable element via the camera 146 or communication interface 150 and generates a corresponding request. The request is transmitted over the network 258 to the enterprise system 200, which processes the request and returns content data to the user device 104, 106 for presentation to the user 110. The physical product 300 thereby serves as a persistent and reusable interface through which the user 110 can access digital content managed by the enterprise system 200, enabling continued interaction over time without requiring modification of the machine-readable element 302 or the physical product 300.

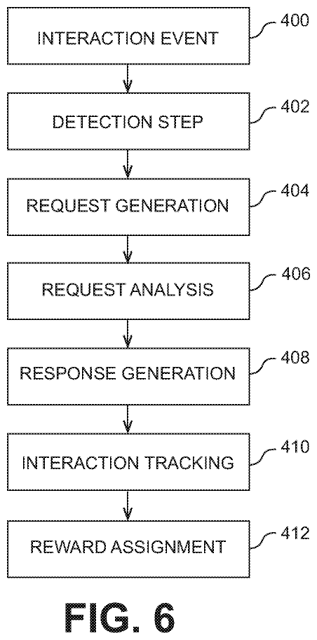

Interaction between the user 110 and the enterprise system 200 is initiated upon the detection of the machine-readable element 302 associated with the physical product 300, as generally illustrated in the process outlined in FIG. 6. In particular, an interaction event 400 may occur when the user 110 positions the user device 104, 106 in proximity to or within a detectable range of the machine-readable element 302, or otherwise captures an image thereof using the camera 146. In response, the user device 104, 106, via operation of the processing device 120, performs a detection step 402 in which encoded or transmitted information associated with the machine-readable element 302 is identified and processed. Additionally, the graphic or indicia may be configured to promote user recognition and encourage interaction with the machine-readable element 302, thereby facilitating repeated engagement with the system 100.

Upon completion of the detection step 402, the user device 104, 106 generates a request 404 based on the detected information. The request 404 may include, as non-limiting examples, an identifier associated with the machine-readable element 302, device-related information, and other contextual data. In some embodiments, the request 404 may further include metadata associated with the interaction event 400, including data generated by the user device 104, 106 at the time of detection of the machine-readable element 302. Such metadata may include, as non-limiting examples, a timestamp, application state information, session data, or validation data generated in response to the detection step 402.

In certain embodiments, at least a portion of the metadata included in the request 404 is generated contemporaneously with detection of the machine-readable element 302, such that the request 404 includes data indicative of a direct interaction event 400. The metadata may be used by the enterprise system 200 in subsequent processing, including evaluation of validation data and determination of whether an access condition is satisfied, as described herein.

The enterprise system 200 receives the request 404 and performs a request analysis step 406 with respect to the request 404 to determine an appropriate request response 408, which may include content data or instructions for rendering content on the user device 104, 106. The request response 408 is transmitted back to the user device 104, 106 over the network 258, and the processing device 120 executes instructions to render the request response 408 via the display 140. In this manner, the interaction event 400 establishes a communication pathway between the physical product 300 and the enterprise system 200, thereby enabling retrieval and presentation of content data associated with the machine-readable element 302.

In some embodiments, the interaction event 400 may occur through different types of machine-readable elements 302, including optical detection of a QR code 304 or proximity-based detection of an NFC tag 306, RFID element, or Bluetooth beacon. Regardless of the specific type of machine-readable element 302, the user device 104, 106 performs substantially similar operations to detect the machine-readable element and initiate communication with the enterprise system 200, thereby providing a unified interaction framework across multiple trigger types.

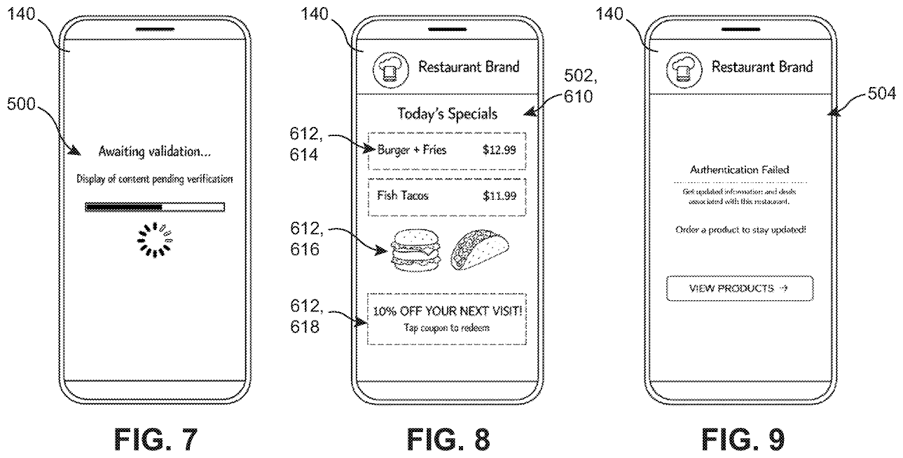

The interaction event 400 may result in presentation of an initial interface on the display 140, such as an access interface 500 as shown in FIG. 7, which serves as an intermediate interface prior to the potential presentation of content via a content interface 502, an example of which is illustrated in FIG. 8, or an alternative (non-authenticated) interface 504, and example of which is illustrated in FIG. 9. In some embodiments, the access interface 500 may be a blank page, a loading page, or a page otherwise indicating that analysis must occur or that permission must be granted prior to presentation of the content interface 502 having the specific content associated with the machine-readable element 302, which may result in the access interface 500 being displayed for a short period of time immediately prior to redirection to the content interface 502. In some embodiments, the access interface 500 may include graphical elements, text, or other indicia prompting the user 110 to perform one or more actions, such as selecting an option, confirming an interaction, or otherwise engaging with the system 100. Presentation of the access interface 500 may occur in response to an initial request 404, and subsequent interaction with the access interface 500 may result in generation of additional data associated with the interaction event 400, including validation data.

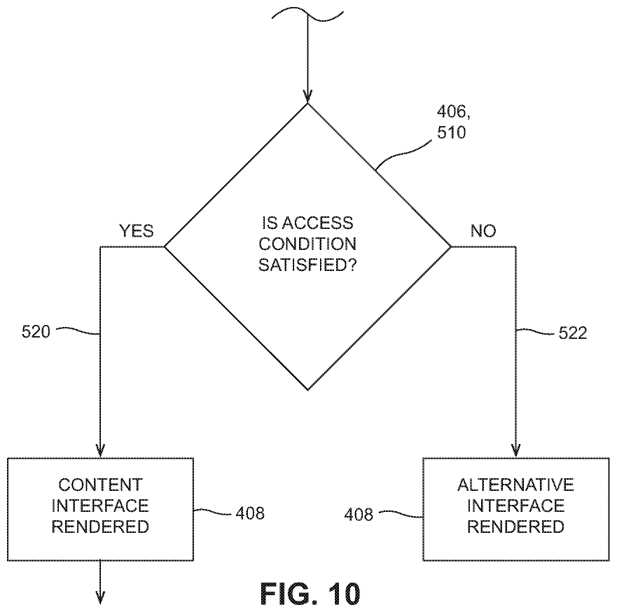

As shown in FIG. 10, the enterprise system 200 may perform a validation process 510 in connection with the interaction event 400, wherein validation data associated with the request 404 is evaluated to determine whether an access condition is satisfied. The validation process 510 may be representative of or an aspect of the request analysis step 406 described herein and shown in FIG. 6. The validation data may include, as non-limiting examples, a token generated in response to detection of the machine-readable element 302, a session identifier associated with the user device 104, 106, timing data associated with the interaction event 400, or other data indicative of a direct interaction with the machine-readable element 302. In some embodiments, the token may be time-limited, single-use, or otherwise configured to expire after a predefined condition, such as passage of time or completion of an interaction.

Where applicable, the enterprise system 200 evaluates the validation data and characteristics of the request 404 to distinguish between requests originating from a direct interaction with the machine-readable element 302 and requests originating from indirect access attempts, including manual navigation, sharing of a resource identifier or other form of access link, or attempts to refresh the same web page, or the like. Such evaluation may include determining whether the request includes valid validation data, whether the request corresponds to a recent detection step 402, or whether the request satisfies one or more predefined access conditions.

Based on the outcome of the validation process 510, the enterprise system 200 may direct the interaction along a valid access path 520 or a restricted access path 522. When the access condition is satisfied, the enterprise system 200 proceeds along the valid access path 520 and transmits content data to the user device 104, 106 for rendering via the content interface 502. When the access condition is not satisfied, the enterprise system 200 may proceed along the restricted access path 522, which may include presenting the alternative interface 504, limiting access to content data, or prompting the user 110 to reinitiate the interaction via the machine-readable element 302.

In the non-limiting example of FIG. 7, the access interface 500 is devoid of content specific to the detected machine-readable element 302 or the associated product 300 and instead includes only an indication that such content is to be presented subject to the outcome of the validation process 510 as described hereinabove. FIG. 8 thus shows an example where the validation process 510 leads to the valid access path 520 and the generation of a corresponding content interface 502 having an association with the detected machine-readable element 302. The content interface 502 of the non-limiting example of FIG. 8 may be representative of content associated with or otherwise originating from a food service provider (restaurant) wherein content of interest to the user 110 may change on a periodic basis such that presenting periodic updates regarding such content is of benefit to the user 110, such as where the food service provider has periodically updated menu items, variable pricing, or time-sensitive discounts. In accordance with this example, the corresponding machine-readable element 302 having been interacted with by the user 110 may be associated with branding of the associated food service provider or otherwise may be representative of typical forms of content accessible via the content interface 502, such as having the appearance of the chef's hat forming an aspect of the content interface 502.

The alternative interface 504 displayed on the user device 104, 106 of FIG. 9 may occur when the authentication process fails, such as when a user attempts to access the digital experience through an indirect method rather than via a direct detection of the machine-readable element 302. The example of FIG. 9 relates to the same food service provider brand as referenced in FIG. 8 to show a possible alternative display 140 when the restricted access path 522 is followed rather than the valid access path 520 associated with FIG. 8. As shown, the interface 504 may include a notification indicating that authentication has failed, along with messaging that informs the user that access to updated information, content, or associated benefits requires interaction with a corresponding physical product 300 having a valid machine-readable element 302. The interface may further present selectable options, such as a link or button to view available products, thereby directing the user toward acquiring a product 300 equipped with the necessary machine-readable element 302. In this manner, the alternative interface 504 not only restricts unauthorized access, but also functions as an engagement and conversion mechanism by educating the user on proper interaction requirements and encouraging legitimate participation through product acquisition. This approach reinforces the integrity of the interaction system while simultaneously promoting continued user engagement and facilitating sales of products associated with the branded food service provider.

The system 100 accordingly provides a structured interaction framework in which detection of a machine-readable element 302 initiates a sequence of operations including request generation, communication with the enterprise system 200, validation of access conditions, and controlled delivery of content data. This framework enables consistent interaction across a variety of physical products 300 and machine-readable element types while allowing the enterprise system 200 to manage and control the resulting user experience.

The enterprise system 200 may be configured to implement a content delivery system for retrieving, assembling, and delivering content data to the user device 104, 106 in response to a validated interaction, as described herein. The content delivery system operates in conjunction with the processing device 220 and storage device 224 of the enterprise system 200 to determine and provide appropriate content data associated with the machine-readable element 302 and the corresponding interaction event 400. In some embodiments, the content delivery system provides data configured to be processed by one or more applications 130 executing on the user device 104, 106, such that at least a portion of the content data is rendered based on execution of instructions at the user device 104, 106.

The content data may include any type of digital information suitable for presentation via the display 140 of the user device 104, 106, including, as non-limiting examples, text content 614, image content 616, video content (not shown), sound content (not shown), and one or more interactive elements 618, examples of which are shown in FIG. 8. In some embodiments, the content data is organized and delivered in accordance with a content template 610, which defines a structure for presentation of the content data on the user device 104, 106. The content template 610 may include one or more content elements 612, each of which corresponds to a portion of the display 140 in which a specific type of content is rendered. In certain embodiments, the content template 610 may be provided as a base structure that is loaded by the user device 104, 106, and the content data corresponding to the content elements 612 may be retrieved separately and populated into the content template 610 after initial loading.

In operation, the enterprise system 200 retrieves content data from the storage device 224, or from one or more external systems 202, 204, and associates the retrieved content data with corresponding content elements 612 of the content template 610. For example, text content 614 may be mapped to a text-based content element, image content 616 may be mapped to an image display region, and interactive elements 618 may be mapped to selectable interface components presented via the display 140. The assembled content data, structured in accordance with the content template 610, is then transmitted to the user device 104, 106 via the network 258.

The user device 104, 106 may execute instructions associated with the content template 610 to request additional content data from the enterprise system 200 after initial rendering of the content interface 502. Such instructions may include, as non-limiting examples, scripts or executable code processed by an application 130, such as a web browser or dedicated application, to perform asynchronous requests for content data. In this manner, portions of the content interface 502 may be populated or updated dynamically after initial presentation, thereby enabling staged loading of content and reducing reliance on a single static response from the enterprise system 200.

Upon receipt of the content data, the processing device 120 of the user device 104, 106 executes instructions to render the content data via the display 140 in accordance with the content template 610. In some embodiments, rendering of the content data may occur dynamically, such that portions of the content are populated or updated after initial presentation of the content interface 502. This may include execution of instructions associated with one or more applications 130, such as the web browser or dedicated application, which interpret and display the content data received from the enterprise system 200.

The content delivery system may be configured to selectively include or exclude particular content elements 612 based on one or more conditions associated with the interaction event 400, the validation process 510, or data stored within the enterprise system 200. As such, the content template 610 may be configured to support variable content configurations, enabling the enterprise system 200 to modify the presentation of content data without requiring modification of the underlying structure of the content template 610.

In further embodiments, the content delivery system may support incorporation of one or more interactive elements 618 within the content interface 502, allowing the user 110 to provide input via the input and output system 136 of the user device 104, 106. Such interactive elements 618 may include, as non-limiting examples, selectable buttons, hyperlinks, input fields, or other interface components that enable further interaction with the enterprise system 200. Input received from the user 110 via such interactive elements 618 may result in additional communications between the user device 104, 106 and the enterprise system 200, thereby enabling extended interaction beyond the initial interaction event 400.

In this manner, the content delivery system enables flexible and dynamic presentation of content data in response to interactions with the physical product 300, allowing the enterprise system 200 to control both the content and the format in which such content is presented to the user 110.

In at least one embodiment, the enterprise system 200 is configured to obtain and manage content data from one or more data sources. The associated data source(s) may include any repository or system capable of storing and providing structured or unstructured data, including, as non-limiting examples, databases, cloud-based storage systems, application programming interfaces, or other external systems 202, 204 communicatively coupled to the enterprise system 200 via the network 258. The data source(s) may be maintained within the enterprise system 200, such as within the storage device 224, or may be maintained externally and accessed by the enterprise system as needed.

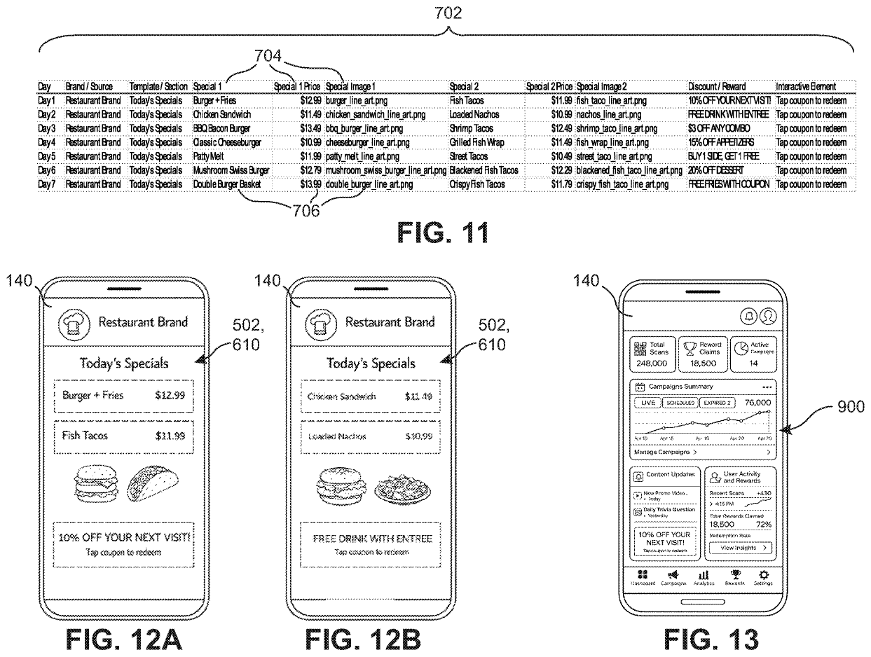

In some embodiments, the data source stores a structured dataset 702 comprising a plurality of data fields 704 arranged in a tabular or otherwise organized format. FIG. 11 illustrates one exemplary structured dataset 702 corresponding to the form and types of content displayed in FIG. 8. Each set of data fields 704 may define a corresponding content entry 706, which represents a discrete unit of content that may be delivered to the user 110. The data fields 704 associated with each content entry 706 may include, as non-limiting examples, text data corresponding to text content 614, image references corresponding to image content 616, and data associated with interactive elements 618, as well as metadata or other information used by the enterprise system 200 to manage and select content. It should be apparent that the data entries 706 associated with “day 1” of the structured dataset 702 of FIG. 11 match the content elements 612 shown in the content template 610 forming the content interface 502 of FIG. 8 in illustrating one example of implementation of the present invention. Alternative forms of data entries 706 may include video content or sound content, as non-limiting additional examples.

The enterprise system 200, via the processing device 220, may be configured to retrieve one or more content entries 706 from the data source in response to a request 404 received from the user device 104, 106. In some embodiments, the enterprise system 200 queries the structured dataset 702 using one or more parameters associated with the request 404, including an identifier corresponding to the machine-readable element 302, data associated with the interaction event 400, or other contextual information. The query may be executed using a defined data access operation that identifies one or more content entries 706 having data fields 704 that satisfy one or more selection criteria.

In certain embodiments, the enterprise system 200 maps the data fields 704 of the selected content entry 706 to corresponding content elements 612 of the content template 610. For example, a data field 704 corresponding to text may be associated with a text content element 614, a data field corresponding to an image reference may be associated with an image content element 616, and a data field corresponding to an interactive function may be associated with an interactive element 618. In this manner, the enterprise system 200 translates structured data from the data source into content data configured for rendering on the user device 104, 106.

The data source may be configured to support modification and updating of the structured dataset 702 independently of the operation of the user device 104, 106. For example, an administrator or other authorized user may modify one or more data fields 704, add new content entries 706, or remove existing content entries 706 from the dataset 702. Such modifications may be performed via the enterprise system 200, via one or more agent devices 212, or via external systems 202, 204. As a result, the content data delivered to the user 110 may be updated dynamically without requiring any modification to the machine-readable element 302 or the associated physical product 300.

The enterprise system 200 may maintain multiple data sources, each of which may correspond to different types of content, different campaigns, or different physical products 300. The enterprise system 200 may select among such data sources based on the machine-readable element 302, the request 404, or other criteria, thereby enabling the system to support a wide range of content delivery configurations.

Accordingly, the use of one or more data sources and structured datasets 702 enables the enterprise system 200 to separate content management from content delivery, thereby allowing content data to be modified, updated, and managed independently of the physical product 300 and the user device 104, 106, while maintaining a consistent interaction framework for the user 110.

The enterprise system 200 may be configured to implement content selection logic for determining which content data is delivered to the user device 104, 106 in response to a given interaction event 400. The content selection logic may be executed by the processing device 220 of the enterprise system 200 and may utilize one or more conditions, rules, or parameters to select an appropriate content entry 706 from the data source.

In some embodiments, the content selection logic includes evaluation of a time condition, which may be based on a current time or date associated with the interaction event 400. The current time or date may be determined using the clock 128 of the user device 104, 106, a corresponding timing component of the enterprise system 200, or a combination thereof. The enterprise system 200 may compare the time condition to one or more scheduling rules to determine which content entry 706 is to be selected for delivery.

The scheduling rules may define, as non-limiting examples, specific time intervals during which particular content entries 706 are active, sequences in which content entries 706 are to be presented over time, or conditions under which content is to be updated or replaced. In one example, the enterprise system 200 may select a first content entry 706 for delivery during a first time period and a second content entry 706 during a subsequent second time period, such that the content data associated with the same machine-readable element 302 changes over time without requiring modification of the physical product 300 or the corresponding machine-readable element 302. For example, FIGS. 12A and 12B show one such change in the content interface 502 generated in reaction to the machine-readable element 302 being interacted with on two different and consecutive days. FIG. 12A is a reproduction of FIG. 8 showing the content associated with “day 1” of content from the structured data set 702 of FIG. 11 whereas FIG. 12B includes content associated with “day 2” of content from the structured data set 702. These figures accordingly show the progression of the content interface 502 depending on the date of detection of the corresponding machine-readable element 302 of the same physical product 300. In such an example, the content may change at a prespecified time each day such as at midnight, as one non-limiting example.

The content selection logic may generate updated content by selecting new content entries 706 from the data source when a scheduling rule indicates that previously delivered content has expired or is no longer valid. The updated content may then be provided to the user device 104, 106 in response to a subsequent interaction event 400, thereby enabling periodic or scheduled updates to the content associated with the machine-readable element 302. In some embodiments, the scheduling rules may be dynamically modified by the enterprise system 200 based on data stored within the storage device 224, including interaction logs or analytics data, as described in greater detail hereinafter, such that content delivery is adjusted over time in response to observed interaction patterns.

In further embodiments, the content selection logic may consider additional parameters beyond the time condition, including, as non-limiting examples, data associated with prior interaction events 400, user-specific data, device-specific data, or other contextual information available to the enterprise system 200. Based on such parameters, the enterprise system 200 may select different content entries 706 for different users 110, for different interaction frequencies by individual users 110, or for different conditions associated with each associated request 404. The content selection logic may apply one or more rules or algorithms to the aforementioned interaction logs or analytics data to adaptively modify selection of content entries 706, thereby enabling data-driven content delivery responsive to system usage.

In this manner, the content selection logic enables the enterprise system 200 to dynamically control the content data delivered to the user 110, thereby providing a flexible framework for time-based content updates, rule-based content selection, and adaptive content delivery in connection with the physical product 300, which remains unchanged during the implementation of such content selection logic.

The enterprise system 200 may be configured to implement an interaction tracking system for recording and analyzing data associated with interaction events 400. The interaction tracking system may be executed by the processing device 220 of the enterprise system 200 and may store data within the storage device 224 in the form of the previously mentioned interaction logs corresponding to one or more prior occurring interactions between the user 110 and the machine-readable element 302.

Each interaction event 400 may result in the generation of an interaction log, which may include, as non-limiting examples, a timestamp associated with the interaction event 400, an identifier associated with the machine-readable element 302, and data associated with the user device 104, 106 performing the interaction event 400. The timestamp may be generated using a clock associated with the enterprise system 200 or the user device 104, 106, and may be used to correlate interaction events 400 over time. The interaction logs may further include data corresponding to the corresponding request 404, the validation process 510 performed with respect to the request 404, or the content data delivered in response to the corresponding interaction event 400.

The enterprise system 200 may process the interaction logs to generate analytics data, which may include aggregated or processed information derived from multiple interaction events 400. For example, the analytics data may include counts of interaction events 400 over a defined time period, distributions of interactions across different machine-readable elements 302, or patterns of user engagement associated with particular content entries 706. The analytics data may be generated by the processing device 220 using data stored within the storage device 224, and may be updated as additional interaction events 400 are recorded.

The enterprise system 200 may provide access to the analytics data via a reporting interface 900, an example of which is shown in FIG. 13, which may be presented to an administrator or other authorized user via one or more user devices, including agent devices 212 associated with the enterprise system 200 or a client thereof. The reporting interface 900 may include graphical representations of the analytics data, such as charts, graphs, or other visual indicators, and may allow the authorized user to review interaction data associated with one or more machine-readable elements 302, physical products 300, or content entries 706, among other potential forms of tracked interaction data.

In some embodiments, the interaction tracking system may be integrated with the content selection logic, such that the analytics data or underlying interaction logs are used to influence selection of content data. For example, the enterprise system 200 may adjust scheduling rules or select different content entries 706 based on patterns identified in the interaction logs, thereby enabling adaptive or data-driven content delivery. The interaction tracking system may accordingly enable the enterprise system 200 to monitor and analyze interactions between users 110 and physical products 300, thereby providing insight into user engagement and supporting dynamic control of content delivery within the system 100.

In certain embodiments, the system 100 may further support additional features and variations that extend the functionality of the interaction between the user 110, the user device 104, 106, and the enterprise system 200. Such features may be implemented in conjunction with the content delivery system, the content selection logic, and the interaction tracking system, and may be selectively enabled or configured based on the specific application or use case associated with the physical product 300.

In some embodiments, the enterprise system 200 may be configured to provide one or more engagement features associated with interaction events 400, including reward-based or gamification features. For example, the enterprise system 200 may track a number or form of interaction events 400 associated with a particular user 110 or user device 104, 106, and may provide content data or interactive elements 618 corresponding to rewards, achievements, or other engagement indicators. Such features may be based on interaction logs and analytics data, and may be presented to the user 110 via the content interface 502. Such tracking of interaction events 400 may include tracking a total number of different interaction events 400 initiated by a specific user 110 (or the associated user device 104, 106 thereof) with respect to a respective physical product 300 (or the associated machine-readable element 302 thereof), a total number of distinct time periods (such as days, weeks, months, etc.) in which such interaction events 400 have occurred, a streak of consecutive time periods in which such interaction events 400 have occurred, the form or type of content interacted with during such interaction events 400, and any combinations or variations of such criteria in determining such rewards, achievements, or other engagement indicators. Any form of reward-based or game-based logic may be utilized in determining when associated goals or reward criteria have been met with respect to such features, as desired.

In further potential embodiments, the system 100 may support transactional or commerce-related functionality. For example, the content data may include interactive elements 618 that enable the user 110 to initiate a transaction, access a product offering, or navigate to a third-party system, such as an external system 202, 204, for completing a transaction. The communication interface 150 of the user device 104, 106 and the communication interface 250 of the enterprise system 200 may facilitate secure transmission of data associated with such transactions, and the enterprise system 200 may coordinate with external systems to complete the transaction, such as dedicated payment systems or secure transaction systems.

In certain embodiments, the system 100 may further support tracking of user-specific interactions and accumulation of engagement data associated with a particular user 110. In such embodiments, the system 100 may include functionality for identifying the user 110, such as through entry of login credentials, association with a user account, or recognition of the user device 104, 106 via device-specific identifiers, session data, or stored authentication information. In some embodiments, validation data, including tokens generated in connection with interaction events 400, may be associated with a particular user profile, such that validated interactions are linked to an identified user 110. Upon identification of the user 110, the enterprise system 200 may associate interaction events 400, transactions, or other activities with a corresponding user profile stored within the storage device 224.

In one example, the enterprise system 200 may assign points, credits, or other engagement values to the user 110 based on interactions with the machine-readable element 302, completion of transactions, or other defined activities. For instance, the user 110 may accumulate points by repeatedly interacting with the physical product 300, engaging with content data, or completing purchases initiated through the system 100. These accumulated points may be stored as part of the user profile and may be redeemed for rewards, discounts, merchandise, or other benefits accessible via the content interface 502 or through integration with external systems 202, 204.

In further embodiments, the enterprise system 200 may evaluate interaction patterns associated with the identified user 110, including, as non-limiting examples, frequency of interaction events 400, duration between interactions, or streak-based activity over time. Based on such evaluation, the enterprise system 200 may provide personalized content data, adjust available rewards, or unlock additional features for the user 110. For example, a user 110 who interacts with the machine-readable element 302 on consecutive days may be presented with enhanced content, increased point values, or access to exclusive offers.

In some embodiments, the system 100 may require the user 110 to provide identifying information at one or more stages of interaction, such as during initial use, prior to redeeming accumulated benefits, or when accessing user-specific content. Alternatively, the system 100 may automatically associate interactions with a user profile based on persistent identifiers associated with the user device 104, 106, thereby enabling recognition of returning users without requiring repeated entry of credentials. In this manner, the system 100 enables individualized tracking and treatment of users, allowing the enterprise system 200 to provide tailored experiences and benefits based on user-specific interaction data.

The enterprise system 200 may further support personalization of content delivered to the user 110. For example, the enterprise system 200 may utilize data associated with prior interaction events 400, user preferences, or other stored data within the storage device 224 to tailor the content data delivered to the user device 104, 106. Such personalization may be implemented in conjunction with the content selection logic, allowing different users or user devices to receive different content in response to interactions with the same machine-readable element 302.

In some embodiments, personalization may be based on identification of the user 110, such as through association with a user account, login credentials, or recognition of the user device 104, 106 as previously described. The enterprise system 200 may maintain a user profile that includes historical interaction data, accumulated engagement values, preferences, and other user-specific information. Validation data, including tokens generated during interaction events 400, may be associated with the user profile, thereby enabling the enterprise system 200 to reliably associate subsequent interactions with the same user 110.

Based on such user-specific data, the enterprise system 200 may tailor the content data to reflect characteristics of the user 110, including prior engagement behavior, frequency of interaction events 400, transaction history, or accumulated points or rewards. For example, a user 110 who has accumulated a threshold number of points through repeated interactions or transactions may be presented with content data that includes reward redemption options, exclusive offers, or enhanced interactive elements 618, while another user interacting with the same machine-readable element 302 may receive introductory or promotional content.

The enterprise system 200 may utilize streak-based or frequency-based interaction data to adjust the content data delivered to the user 110. For example, users exhibiting consistent interaction patterns over a defined time period may be provided with progressively modified content, increased point allocations, or access to additional features. The enterprise system 200 may evaluate such patterns using interaction logs and analytics data, and may modify content selection logic accordingly to provide adaptive and user-specific content delivery.

The described personalization may also be applied dynamically within a single interaction session. For example, the enterprise system 200 may adjust content elements 612 presented within the content interface 502 based on user input received via interactive elements 618, or based on real-time evaluation of user behavior during the interaction. In this manner, the system 100 enables both persistent personalization across multiple interaction events 400 and dynamic personalization within individual interactions, thereby enhancing the relevance and effectiveness of content delivered to the user 110.

In some embodiments, the system 100 may further support interaction with human agents 210 or virtual agents 214 associated with the enterprise system 200. For example, a user 110 may access assistance through the content interface 502, which may include interactive elements 618 enabling communication with a human agent 210 via an agent device 212, or with a virtual agent 214 configured to provide automated assistance. Such interactions may facilitate onboarding, configuration of content, troubleshooting, or other support functions associated with use of the system 100.

The enterprise system 200 may be configured to support interaction with one or more client entities, such as advertisers, brands, or other business entities (hereinafter “client companies”), that utilize the system 100 to deploy machine-readable elements 302 in connection with physical products 300 for purposes of engaging users 110. In such embodiments, the enterprise system 200 may provide one or more interfaces or tools that enable a client company to register with the system, define campaign parameters, and configure the manner in which content data is delivered to users 110 in response to interaction events 400.

A client company may engage the enterprise system 200 to create or procure physical products 300 incorporating machine-readable elements 302, including QR codes 304, NFC tags 306, or other elements as described herein. The client company may provide branding assets, such as logos, graphics, or design specifications, which are incorporated into the physical product 300, while the enterprise system 200 ensures that the machine-readable element 302 is properly configured for interaction with the system 100. The enterprise system 200 may be configured to generate, define, or otherwise control one or more aspects of the creation and integration of the machine-readable element 302 and/or the physical product 300. For example, the enterprise system 200 may generate encoding data associated with a machine-readable element 302, including identifiers, access parameters, or data structures that are subsequently encoded within a QR code 304, NFC tag 306, or other machine-readable format. The enterprise system 200 may further define structural, graphical, or layout characteristics of the machine-readable element 302, including parameters associated with a shaped QR code region 312, a graphical or branded design region 314, or a multi-layer assembly 320.

In some embodiments, the enterprise system 200 may transmit data, instructions, or configuration parameters to one or more manufacturing systems, fabrication devices, or production processes to cause the machine-readable element 302 to be formed, embedded, or otherwise incorporated into the physical product 300. Such formation may include, as non-limiting examples, engraving, laser etching, embossing, stamping, printing, or assembly of layered components, as described herein. In this manner, the enterprise system 200 may maintain a coordinated association between (i) generated encoding data, (ii) physical implementation of the machine-readable element 302 within the physical product 300, and (iii) content data and access control logic applied during subsequent interaction events, thereby enabling integrated control over both physical and digital aspects of the system 100.

The enterprise system 200 may provide content management functionality that enables the client company to define, upload, or otherwise control the content data associated with one or more machine-readable elements 302. For example, the enterprise system 200 may provide a template interface 610 that defines a structure for presenting content to users 110, and the client company may populate one or more content elements 612 with text content 614, image content 616, interactive elements 618, or other content. In some embodiments, the enterprise system 200 may provide default templates, while in other embodiments the client company may customize the layout, structure, or behavior of the content interface 502.

In certain embodiments, control over content data may be shared between the enterprise system 200 and the client company. For example, the client company may define base content or campaign-specific content, while the enterprise system 200 may apply content selection logic, scheduling rules, or personalization features to determine how and when such content is delivered to users 110. In this manner, the system 100 enables both centralized control and client-driven customization of content delivery.

The system 100 may support integration between content delivery and commerce or promotional features associated with the client company. For example, content data presented to the user 110 may include links, buttons, or other interactive elements 618 that direct the user to a website, marketplace, or digital platform associated with the client company. Additionally, rewards, points, or other engagement values accumulated by the user 110 may be associated with products, services, or promotional offerings provided by the client company, such that accumulated engagement may be redeemed for merchandise, discounts, or other benefits associated with the client company.

The enterprise system 200 may support coordination of promotional campaigns in which the physical products 300 serve as distributed access points for engaging users 110. The enterprise system 200 may assist the client company in determining how machine-readable elements 302 are deployed across products, how content data is scheduled or updated over time, and how user interactions are tracked and analyzed. For example, the enterprise system 200 may enable the client company to define campaign durations, content update intervals, or reward structures associated with interaction events 400.

The enterprise system 200 may beneficially provide access to analytics data and reporting interfaces 900 that enable the client company to evaluate performance of a campaign or deployment of physical products 300. Such analytics may include, as non-limiting examples, counts of interaction events 400, user engagement patterns, geographic distribution of interactions, frequency of repeat interactions, or conversion data associated with transactions initiated through the system 100. The client company may utilize such analytics data to refine content, adjust campaign strategies, or modify deployment of machine-readable elements 302 across physical products 300.

The enterprise system 200 may accordingly facilitate coordinated interaction between client companies and users 110 by enabling the client companies to deploy branded physical products 300, control and manage associated content data, and analyze user engagement resulting from interaction events 400. The system 100 thereby provides a platform through which client companies can engage users through physical products 300 while maintaining dynamic control over digital content and associated user experiences.

Referring again to FIG. 6, following the request response step 408, the enterprise system 200 may accordingly perform an interaction tracking step 410 in which data associated with the interaction event 400 is recorded and associated with the corresponding machine-readable element 302, physical product 300, and client company. The interaction tracking step 410 includes storing data identifying the user device, any associated user account, the time and location of the interaction event 400, and a frequency or sequence of prior interaction events associated with the same machine-readable element 302 or physical product 300. The enterprise system 200 maintains this interaction data across a plurality of interaction events 400 to establish a record of engagement associated with each machine-readable element 302 and each client company, thereby enabling tracking of repeated interactions by individual users 110 and across a population of users.

Based on the tracked interaction data, the enterprise system 200 performs a reward assignment step 412 in which value is assigned to a user 110 in response to one or more interaction events 400 meeting defined criteria. The assigned value may include points, credits, a form of digital currency, or other accumulated value associated with the machine-readable element 302 and corresponding client company. The enterprise system 200 determines the assigned value based on factors including a number of interaction events 400, a frequency or sequence of repeated interactions, or satisfaction of defined interaction conditions, including streak-based interaction thresholds in which value increases based on consecutive interaction events occurring over time. The assigned value is associated with a user profile corresponding to the user device and is stored for subsequent use.

The enterprise system 200 enables redemption of the assigned value in association with the corresponding client company. The user 110 may redeem accumulated value through interaction with the enterprise system 200 to obtain benefits associated with the client company, including promotional offers, discounts on products or services, access to special content, eligibility for prizes, or the ability to purchase goods or services using the accumulated value. The enterprise system 200 maintains an association between the assigned value and the originating machine-readable element 302 and client company, thereby ensuring that value earned through interaction with a given physical product 300 is redeemable in connection with that client company.

The enterprise system 200 thus operates as a platform supporting a plurality of client companies, each having distinct physical products 300, machine-readable elements 302, content data, and reward structures. Interaction tracking step 410 and reward assignment step 412 are performed across interaction events 400 associated with multiple machine-readable elements 302 and multiple client companies, such that interaction data and assigned value are maintained separately for each client company. The enterprise system 200 thereby enables independent control of content, access conditions, and reward systems for each client company while utilizing a common infrastructure for processing interaction events 400.

Through repeated execution of the interaction tracking step 410 and reward assignment step 412, the enterprise system 200 establishes a continuous interaction loop in which users 110 are encouraged to repeatedly interact with machine-readable elements 302 associated with physical products 300. The enterprise system 200 dynamically updates assigned value and available benefits based on ongoing interaction data, thereby promoting continued engagement with the physical products 300 and associated client companies. The system 100 thus facilitates an exchange of value in which users 110 receive benefits through interaction with physical products 300, and client companies receive increased engagement, interaction data, and opportunities for delivering targeted content and promotions.

In further embodiments, each machine-readable element 302 associated with a physical product 300 may include or be associated with a unique identifier that distinguishes the machine-readable element 302 from other machine-readable elements 302 deployed within the system 100. The unique identifier may be encoded within the machine-readable element 302, stored within the enterprise system 200, or otherwise associated with the machine-readable element 302 in a manner that allows interaction events 400 to be attributed to a specific instance of the physical product 300 and corresponding machine-readable element 302.

In such embodiments, the enterprise system 200 may track interaction events 400 not only with respect to users 110, but also with respect to the specific machine-readable element 302 that initiated the interaction. This enables the enterprise system 200 to associate interaction data, including frequency of interactions, number of distinct users, or patterns of engagement, with a particular physical product 300 and associated machine-readable element 302, or with a user 110 in possession of that product/element. For example, a first user 110 may obtain a physical product 300 incorporating a machine-readable element 302 having a unique identifier, and subsequent interactions by additional users 110 with that machine-readable element 302 may be attributed to the first user.

The enterprise system 200 may thus utilize such data to provide incentives or rewards to the user 110 associated with the specific machine-readable element 302. For example, the system 100 may assign points, credits, or other engagement values to the user 110 based on a number of interaction events 400 associated with the corresponding machine-readable element 302, including interactions performed by other users. In some embodiments, increased value may be assigned based on interactions by new or unique users, thereby incentivizing distribution or promotion of the physical product 300 to a broader audience.

As such, the user 110 associated with the specific physical product 300 or element 302 may effectively promote or advertise content associated with a client company by encouraging other users to interact with the associated machine-readable element 302. The enterprise system 200 may track such interactions and provide rewards to the user 110 in exchange for facilitating engagement with the content data associated with the client company. Such rewards may include points redeemable for merchandise, discounts, or other benefits as described herein.

This configuration may provide advantages to client companies utilizing the system 100, as the distribution of physical products 300 to users 110 may result in organic promotion of content and increased user engagement without requiring direct marketing efforts by the client company. The enterprise system 200 may provide analytics data to the client company indicating how interactions are distributed across different machine-readable elements 302 tied to specific users 110, how many unique users 110 are engaging with each element 302, and how effectively individual products 300 are generating engagement. This enables the client company to identify high-performing products 300 or users 110 and to adjust campaigns, rewards structures, or content delivery strategies accordingly. The system 100 according to such a configuration accordingly supports a distributed engagement model in which users 110 associated with physical products 300 are incentivized to promote interaction with machine-readable elements 302, while client companies benefit from increased visibility, user engagement, and actionable analytics derived from such interactions.

The present invention is not limited to any of the specific examples disclosed herein. As described in detail hereinabove, the system 100 may support a wide range of physical products 300 and deployment configurations. For example, the machine-readable element 302 may be incorporated into drinkware, apparel, accessories, or other items, and may be implemented using various technologies including QR codes 304, NFC tags 306, RFID elements, or Bluetooth beacons. The enterprise system 200 may accordingly be configured to support multiple campaigns, content sets, or product categories simultaneously, with content data managed and delivered independently for each. Thus, the system 100 provides a flexible and extensible platform that can be adapted to a wide variety of applications, enabling enhanced interaction between physical products 300 and digital content while leveraging the underlying infrastructure of the enterprise system 200, the user devices 104, 106, and the network 258.

In various embodiments, the systems and methods described herein may be implemented using different configurations of devices, components, and communication mechanisms without departing from the scope of the present invention. For example, while certain embodiments have been described with reference to a mobile device 106 and a computing device 104, it should be understood that any suitable user device having a processing device 120, a memory device 122, and a communication interface 150 may be utilized to perform the functions described herein. Such devices may include wearable devices, kiosks, embedded systems, or other computing platforms capable of interacting with a machine-readable element 302 and communicating with the enterprise system 200.

The machine-readable element 302 may be implemented using a variety of technologies and configurations. While examples described herein include QR codes 304, NFC tags 306, RFID elements, and Bluetooth beacons, other technologies capable of encoding or transmitting information to a user device 104, 106 may be utilized. Additionally, the machine-readable element 302 may be integrated into the physical product 300 in various forms, including embedded configurations, surface-mounted configurations, removable elements, or combinations thereof.

The enterprise system 200 may be implemented as a single computing system 206 or as a distributed system comprising multiple computing systems, servers, or cloud-based resources. The functions described as being performed by the enterprise system 200, including content delivery, data management, validation, and analytics, may be distributed across multiple systems or combined within a single system, depending on the implementation. Similarly, one or more external systems 202, 204 may be utilized to provide supplemental functionality, such as content hosting, data storage, transaction processing, or integration with third-party services.

The communication between the user device 104, 106 and the enterprise system 200 may be implemented using various communication protocols and network configurations. The network 258 may include one or more wired or wireless networks, and communication may occur using any suitable protocol, including internet-based protocols, short-range communication protocols, or combinations thereof. Additionally, certain functions may be performed locally on the user device 104, 106, remotely on the enterprise system 200, remotely via communication with external servers or sources 202, 204, or in a distributed manner across any such devices or resources.

Any of the content delivery system, the data source, the content selection logic, and the interaction tracking system may be implemented using different data structures, algorithms, or processing techniques than those explicitly described herein. For example, content data may be stored in relational databases, non-relational databases, flat files, or other data storage formats, and may be retrieved using queries, application programming interfaces, or other data access mechanisms. Similarly, the content selection logic may utilize rule-based processing, algorithmic selection, or machine learning techniques to determine which content is delivered.

The sequence of operations described herein may be modified, reordered, or combined. For example, one or more steps of the disclosed method may be performed in a different order, performed concurrently, or omitted in certain implementations. Additionally, certain operations may be performed automatically by one or more components of the system 100, or may be performed in response to user input received via the user device 104, 106, as desired. The present invention may thus be implemented in a wide variety of configurations and environments, and the specific embodiments described herein are provided for illustrative purposes only and are not intended to limit the scope of the invention as disclosed herein.

The present invention addresses shortcomings associated with conventional systems for linking physical objects to digital content. In existing implementations, machine-readable elements such as QR codes or similar identifiers are often configured to resolve to static resources or fixed endpoints, and corresponding systems generally rely on generic redirection techniques that do not preserve meaningful context regarding how a request originated. As a result, such systems typically lack the ability to dynamically control content presentation in response to physical interaction with an object, to distinguish between requests arising from direct detection of a machine-readable element and indirect access attempts such as shared-link navigation, or to maintain a reliable association between a specific physical product and the digital content, user data, and analytics generated through subsequent interactions. These shortcomings lead to inefficient content management, limited deployment flexibility, weak access control, and reduced ability to track or analyze engagement tied to particular products, users, campaigns, or time periods.

Conventional systems also fail to provide a coordinated technical architecture for managing content independently of the physical product while still preserving functional coupling between the physical product and the resulting user experience. In particular, known systems typically do not integrate physical trigger detection, request metadata generation, validation data evaluation, structured dataset querying, content-template mapping, asynchronous content population, and interaction logging within a unified processing framework. Likewise, conventional systems generally do not support scheduled content replacement, rule-based content selection, user-specific personalization, or controlled campaign management by client companies using distributed branded products. As a result, prior approaches are not well suited to deliver dynamic, time-dependent, user-specific, and analytically trackable content through persistent physical products deployed across multiple campaigns, businesses, and product categories.

The present invention provides a technical solution to these deficiencies by implementing a system 100 in which interaction with a machine-readable element 302 associated with a physical product 300 initiates a controlled sequence of operations performed by the user device 104, 106 and the enterprise system 200. In particular, the system is configured to perform a detection step 402, generate a structured request 404 containing interaction-related metadata, transmit the request over the network 258, evaluate validation data in a validation process 510, determine whether an access condition is satisfied, and selectively proceed along a valid access path 520 or a restricted access path 522. In some embodiments, the validation data may include time-limited or single-use tokens, session identifiers, timing data, or other metadata generated contemporaneously with direct detection of the machine-readable element 302, thereby enabling the enterprise system 200 to distinguish requests arising from actual physical interactions from requests arising from indirect access attempts.

Conventional systems that rely on static links or generic redirection mechanisms are susceptible to circumvention techniques in which access to content is obtained without a corresponding physical interaction with the associated product. For example, once a link or address corresponding to a machine-readable element is obtained, a user may access the associated content through link sharing, bookmarking, manual navigation to a web address, repeated page refresh operations, or other indirect access methods that are not tied to a detection event of the machine-readable element. In such systems, rewards, incentives, or access-controlled content may be improperly obtained or repeatedly accessed without requiring a corresponding physical interaction with the product, thereby undermining the intended association between the physical product and the resulting digital experience.

The present invention overcomes these shortcomings through the use of validation data generated in connection with direct detection of the machine-readable element 302 and evaluated during the validation process 510. In particular, the enterprise system 200 evaluates data associated with the request to determine whether the request is causally linked to a detection event of the machine-readable element 302, including by evaluating device-related data indicating that the request was generated by a detection operation of the user device 104, 106, data associated with a token or session identifier generated in response to the detection event and included in or associated with the request, and timing data indicating that the request was generated within a defined time interval following the detection event. By requiring that requests satisfy these validation conditions, the enterprise system 200 prevents access to content and associated rewards through indirect methods such as link sharing, bookmarking, manual navigation, or replay of previously obtained requests. As a result, access to content, accumulation of value, and assignment of rewards are constrained to interaction events 400 that are verified as originating from direct physical interaction with the machine-readable element 302, thereby preserving the integrity of the association between the physical product 300 and the resulting digital interactions.

The invention further improves computer-based content delivery by separating physical trigger deployment from content management while maintaining a technical linkage between them. The enterprise system 200 retrieves one or more content entries 706 from one or more data sources, including structured datasets 702 having data fields 704, and maps those data fields to corresponding content elements 612 of a content template 610 to generate content data for presentation through a content interface 502. In some embodiments, the user device 104, 106 loads a base interface and subsequently retrieves additional content data through asynchronous requests executed by one or more applications 130, such that portions of the content interface 502 are dynamically populated after initial loading. This architecture provides more than generic web linking because it uses coordinated client-side and enterprise-side processing to transform structured content records into rendered interface content in response to validated physical interactions.

The invention also addresses technical shortcomings relating to static content behavior by implementing content selection logic that evaluates time conditions, scheduling rules, interaction history, user-specific data, device-specific data, and analytics-derived information in selecting or generating updated content. In this manner, the same product 300 and/or associated machine-readable element 302 may remain physically unchanged while the enterprise system 200 dynamically alters the corresponding content data over time, including by scheduled replacement, adaptive selection, personalization based on user profiles, and modification based on interaction logs and analytics data. The system therefore improves the flexibility and responsiveness of content delivery systems by enabling rule-based and data-driven control of rendered content without requiring modification of the physical trigger itself or the issuing of additional products and corresponding triggers.

The present invention further improves technical coordination between identity, validation, and engagement tracking. Validation data, including tokens generated during interaction events 400, may be associated with specific user profiles so that the enterprise system 200 can recognize returning users, differentiate among users interacting with the same machine-readable element 302, and tailor content data, reward structures, point allocations, streak-based benefits, and transaction-related opportunities accordingly. In still further embodiments, each machine-readable element 302 may include or be associated with a unique identifier, enabling the enterprise system 200 to distinguish among individual deployed products, attribute interactions to specific products and their associated users, count unique-user interactions, and support incentive structures in which owners or distributors of particular products are rewarded based on engagement generated through those products 300. These mechanisms improve the technical ability of the system to maintain persistent, granular association among products, users, interactions, and resulting benefits over time.

The invention additionally improves operation of distributed campaign-management systems used by client companies. The enterprise system 200 may provide client companies with interfaces for defining campaign parameters, populating or customizing content templates 610, scheduling content updates, associating rewards or commerce functions with branded physical products 300, and reviewing analytics data through reporting interfaces 900. Because the enterprise system 200 maintains product-associated interaction logs, user-specific engagement data, and campaign-specific content structures, it enables client companies to deploy branded physical products 300 as persistent access points while still retaining dynamic control over digital experiences and measurable campaign performance. This improves technical management of distributed content campaigns by centralizing content scheduling, validation, analytics, and rendering logic within a coordinated system architecture rather than relying on static links or unmanaged redirection.

Accordingly, the present invention improves the operation of computer-based content delivery and interaction systems by introducing specific technical mechanisms for coordinating physical trigger detection, metadata-bearing request generation, validation-driven access control, structured data retrieval, content-template population, asynchronous rendering, adaptive content selection, user-specific personalization, product-specific interaction attribution, and analytics-driven campaign control. These features are applied in a concrete technological environment involving the physical product 300, machine-readable element 302, user device 104, 106, enterprise system 200, and network 258, and collectively provide a practical technical solution to limitations of conventional systems. The resulting improvements include enhanced control over access to digital content, improved maintenance of associations among physical products, users, and rendered content, improved flexibility in updating and scheduling content, improved tracking and attribution of interaction events, and improved functionality of distributed engagement systems used by client companies and end users alike.

The present invention further addresses limitations of conventional machine-readable elements by providing physically integrated encoding structures that are not merely printed overlays or replaceable labels, but instead form part of the underlying structure of the physical product 300. In contrast to prior approaches that rely on externally applied graphics or static printed codes, the machine-readable element 302 may be formed through material transformation processes such as engraving, laser etching, embossing, stamping, or permanent printing, thereby creating a physically defined encoding pattern within the surface of the product itself. These processes result in structural modifications to the product that define the encoded information through variations in depth, texture, reflectivity, or material composition, rather than through superficial application of ink or imagery. As a result, the machine-readable element 302 exhibits improved durability, resistance to wear, and persistence over time, while also maintaining reliable detectability by the user device 104, 106. Additionally, by incorporating the encoded structure within a shaped QR code region 312 and integrating it with a graphical or branded design region 314, the invention enables simultaneous achievement of functional encoding and visually distinctive product design, thereby overcoming conventional tradeoffs between machine readability and aesthetic presentation.

The invention further improves upon known implementations of proximity-based communication elements by providing a physically structured, multi-layer assembly 320 that enables integration of communication functionality with durable and customizable visual presentation. Unlike conventional NFC tags that are often implemented as generic, visually distinct components with limited adaptability to product design, the multi-layer assembly 320 is configured as an integrated structure, such as a sticker-like or label-like component, in which the outer layer 322 provides a branded or decorative appearance while underlying layers support communication functionality and operational reliability. The communication layer 324, shielding layer 326, and adhesive layer 328 are arranged to maintain effective signal transmission and compatibility with a variety of product surfaces, including materials that would otherwise interfere with NFC operation. This layered configuration provides a physically tangible and manufacturable structure that enables deployment of machine-readable elements across a wide range of product types without sacrificing either communication performance or visual integration. Accordingly, these structural features represent more than abstract data encoding or generic communication techniques, as they provide concrete physical implementations that transform product surfaces and assemblies to achieve reliable interaction, durable construction, and enhanced integration of functional and aesthetic characteristics within real-world products.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A computing system for controlling access to digital content in response to interaction with a machine-readable element associated with a physical product, the computing system comprising:
one or more processors and one or more non-transitory computer-readable media storing instructions that, when executed by the one or more processors, cause the enterprise computing system to:
receive, from a user device, a request generated based on direct detection of the machine-readable element associated with the physical product by the user device;
identify the machine-readable element or the physical product based on data included in the request;
determine whether an access condition is satisfied, including determining whether the request originated from direct detection of the machine-readable element by the user device, based on at least one of device-related data, session-related data, or detection context data;
select, in response to determining that the access condition is satisfied, content data based on the identified machine-readable element or physical product and at least one of one or more scheduling rules, personalization data, or campaign parameters; and
cause transmission of the selected content data to the user device for presentation to a user thereof.

2. The computing system of claim 1, where an alternative interface is transmitted to the user device in response to determining that the access condition is not satisfied.

3. The computing system of claim 1, wherein the request includes an identifier associated with the machine-readable element.

4. The computing system of claim 3, wherein the identifier uniquely corresponds to a specific instance of the physical product among a plurality of physical products.

5. The computing system of claim 1, wherein determining whether the request originated from direct detection of the machine-readable element includes evaluating at least one of:
device-related data indicating that the request was generated by a detection operation of the user device directed to the machine-readable element, rather than by navigation to a previously obtained link;
data associated with a token or session identifier generated in response to detection of the machine-readable element and included in or associated with the request; or
timing data indicating that the request was generated within a predetermined time interval following detection of the machine-readable element.

6. The computing system of claim 1, wherein the personalization data includes data associated with a user profile corresponding to the user device or a user thereof.

7. The computing system of claim 1, wherein the one or more scheduling rules define temporal conditions under which different content data is selected for transmission.

8. The computing system of claim 1, wherein the computing system is further configured to maintain an association among the machine-readable element, one or more users, and interaction data corresponding to prior requests.

9. The computing system of claim 8, wherein the computing system is further configured to determine one or more engagement metrics based on the interaction data.

10. The computing system of claim 9, wherein the computing system is further configured to associate the engagement metrics with at least one of a reward, incentive, or accumulated value linked to the machine-readable element or the physical product.

11. The computing system of claim 1, wherein the content data is generated by populating a content template using data retrieved from a structured dataset.

12. The computing system of claim 1, wherein the machine-readable element comprises one of a visually integrated encoding structure formed within a graphical design region of the physical product or a near-field communication device integrated into an assembly including an outwardly visible graphic.

13. A method for providing controlled access to digital content via a physical product, the method comprising:
generating, by a computing system, encoding data associated with a machine-readable element;
causing the machine-readable element to be formed or incorporated into a physical product based on the encoding data;
associating, by the computing system, the machine-readable element with content data and one or more access conditions;
receiving, by the computing system, a request generated by a user device based on detection of the machine-readable element;
determining, by the computing system, whether an access condition is satisfied based on at least one of device-related data, session-related data, or detection context data;
selecting, by the computing system, content data based on the machine-readable element and at least one of scheduling rules, personalization data, or interaction history; and
causing, by the computing system, presentation of the selected content data on the user device in reaction to the access condition being satisfied.

14. The method of claim 13, wherein causing the machine-readable element to be formed or incorporated into a physical product includes at least one of engraving, etching, or embossing a graphic with respect to an exposed surface of the physical product.

15. The method of claim 14, wherein the graphic forms a quick-response code in the exposed surface of the physical product.

16. The method of claim 15, wherein the graphic includes an encoded region disposed relative to a branded design region while maintaining machine readability of the encoded region.

17. The method of claim 13, wherein causing the machine-readable element to be formed or incorporated into the physical product includes affixing a multi-layer structure to the physical product.

18. The method of claim 17, wherein the multi-layer structure includes at least a cover layer having a graphic formed thereon, a communication layer for detection by the user device, and an adhesive layer for affixing the multi-layer structure to the physical product.

19. The method of claim 18, wherein the communication layer forms a near-field communication device.

20. The method of claim 13, wherein determining whether the access condition is satisfied includes determining whether the request originated from direct detection of the machine-readable element by the user device.
